(19) United States
(12) Patent Application Publication
(10) Pub. No.: US 2022/0125063 A1
(43) Pub. Date: Apr. 28, 2022

(54) FINGER PLATE SYSTEM FOR PICKER HUBS

(71) Applicant: William Clint McDonald, Petal, MS (US)

(72) Inventor: William Clint McDonald, Petal, MS (US)

(21) Appl. No.: 17/080,971

(22) Filed: Oct. 27, 2020

(51) Int. Cl. A22C 21/02

(52) U.S. Cl. CPC A22C 21/022; A22C 21/028

(57) ABSTRACT

A finger plate system for a picker hub that employs fingers to pick poultry feathers. The system includes a base plate that attaches to the picker hub and a top plate. The top plate has finger holes and attaches to said base plate. The finger holes are adapted to receive the fingers. The attachment of said top plate to said base plate traps and holds the fingers.

### BACKGROUND

The present invention generally relates to poultry feather removal. More specifically, the present invention relates to picker hubs with picker fingers used on machines to remove poultry feathers.

Currently machines to remove feathers from poultry employ picker hubs with picker fingers. The fingers are made of a rubber material and must be replaced on a weekly basis. Picker fingers have to be soaked in soap water to lubricate the picker fingers so that the fingers can be installed by pulling the fingers into a picker reel with pliers. The fingers must be cut out with knives for removal, which is strenuous work requiring many man hours. It takes sixteen hours to replace fingers at a normal poultry plant.

It is an object of the present invention to provide a device which shortens replacement time and effort of fingers on a poultry feather picker.

### SUMMARY

A finger plate system for a picker hub that employs fingers to pick poultry feathers. The system includes a base plate that attaches to the picker hub and a top plate. The top plate has finger holes and attaches to said base plate. The finger holes are adapted to receive the fingers. The attachment of said top plate to said base plate traps and holds the fingers.

### BRIEF DESCRIPTION OF DRAWINGS

FIG. 1 is a perspective view of a finger plate system according to the present invention.

FIG. 2 is a perspective view of a base plate according to the present invention.

FIG. 3 is a perspective view of a key coupler according to the present invention.

FIG. 4 is a perspective view of a key coupler according to the present invention.

FIG. 5 is a perspective view of a top plate according to the present invention.

FIG. 6 is a perspective view of a base plate and top plate according to the present invention.

### DETAILED DESCRIPTION

The present invention is finger plate system is an improvement for picker hubs which allows for quick changing of the fingers used to pick poultry feathers. The finger plate system eliminates the need to cut out thousands of fingers with knives in a plant. The finger plate system allows a user to loosen one bolt and the fingers fall out and can be replaced with new fingers. This reduces a sixteen hour task requiring numerous employees to about a four hour task.

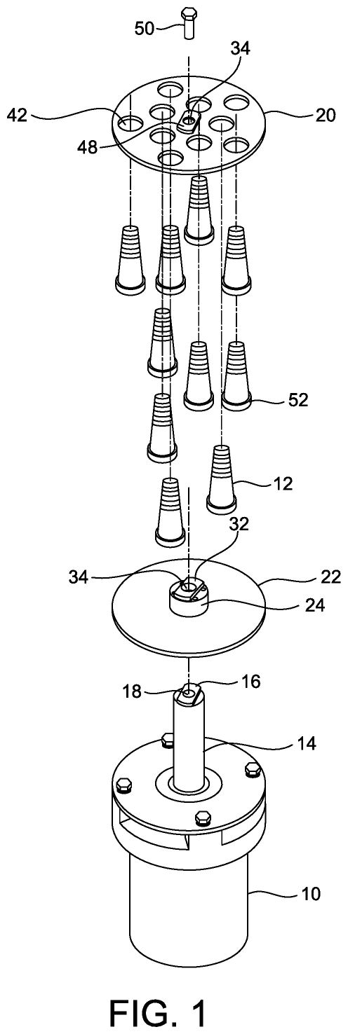

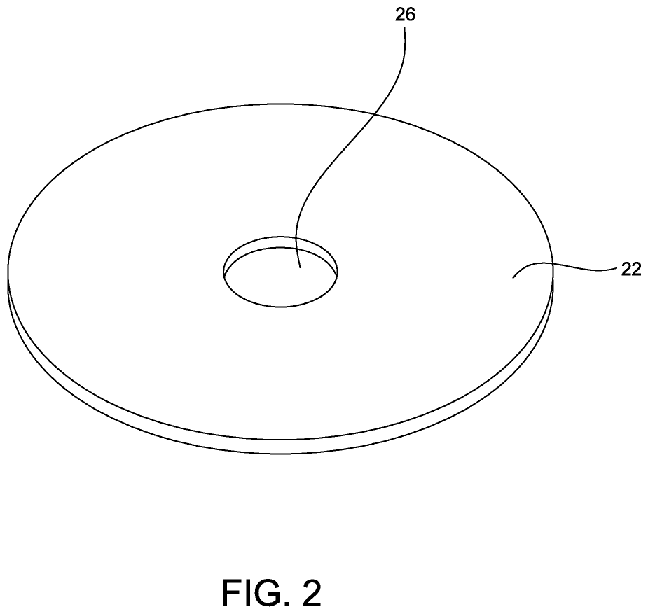

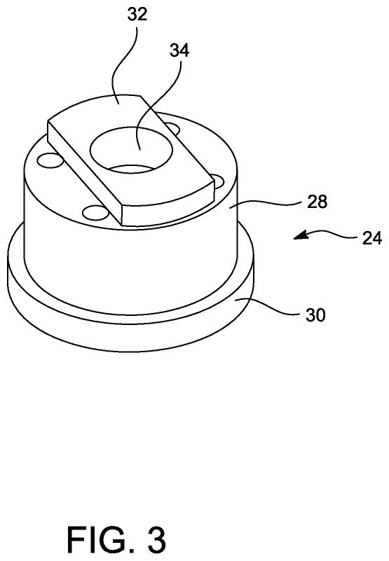

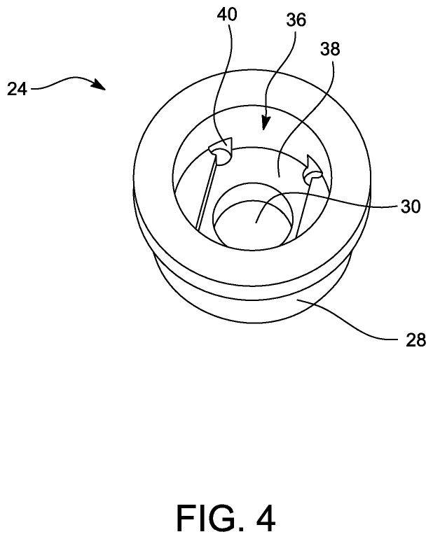

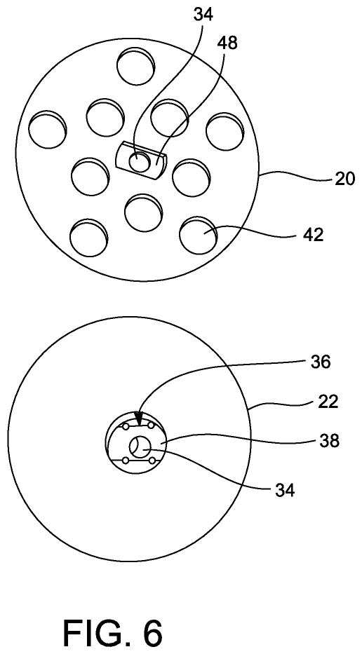

FIG. 1 shows an exploded view of the finger plate system. FIG. 1 shows the picker hub 10 and fingers 12, which are prior art. The picker hub 10 includes a shaft 14. The shaft 14 includes a key 16 at the top of the shaft 14 and a threaded bolt hole 18 in the center of the key 16 and shaft 14. The key 16 of the shaft 14 is shown as a rectangular shape with rounded ends. The finger plate system includes a base plate assembly and top plate 20. Components of the base plate assembly are shown in FIGS. 1-3 and 5-6. The base plate assembly includes base plate 22 and key coupler 24. The base plate 22 is a flat round plate with a key coupler hole 26. The base plate 22 includes a bottom side and top side. The key coupler 24 is cylinder shape. The key coupler 24 includes a spacer 28 with a top and bottom. The bottom of the spacer 28 includes a flange 30. The top of the spacer 26 includes a key 32 with a bolt hole 34. The key 32 of the spacer 26 is shown as a rectangular shape with rounded ends. FIG. 4 shows a view from the bottom of the key coupler 24. The bottom includes a key cavity 36 to receive the shaft 14 of the picker hub 10. The key cavity 36 includes a keyway 38 to receive the key 16 on top of the shaft 14 of the picker hub 10. The keyway 38 of the key cavity 36 matches the shape of the key 16 on top of the shaft 14 of the picker hub 10. The keyway 38 includes milled out corners 40 to allow passage of the corners on the key 16 on top of the shaft 14. The key coupler 24 is pressed into the key coupler hole 26 of the base plate 22 from the bottom side so that the flange 30 is pressed against the bottom side and the spacer 26 extends out from the top side of the base plate 22.

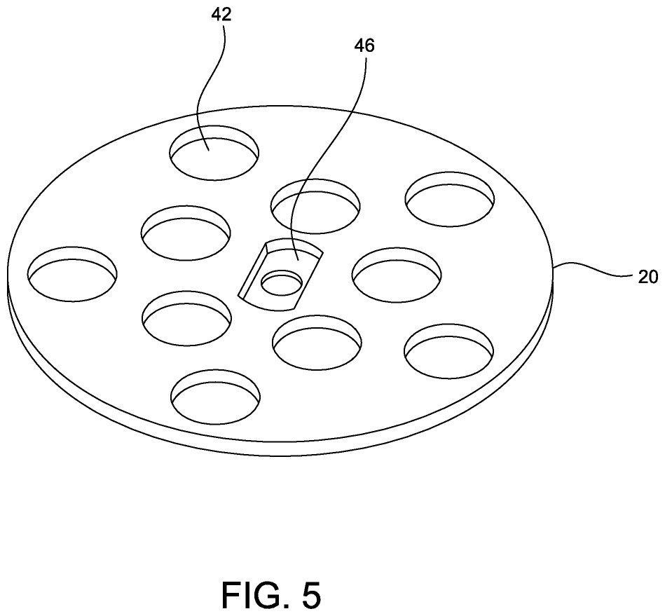

The top plate 20 is shown in FIGS. 1 and 5-6. The top plate 20 includes bottom side and top side. The top plate 20 includes finger holes 42 to receive the fingers 12. FIG. 5 shows the bottom side of the top plate 20. The bottom side includes a keyway 46 that matches the shape of the key 32 of the key coupler 24. The keyway 46 of the top plate 20 is shown as a rectangular shape with rounded ends. The top plate 20 includes a key 48 extending out from the top side that includes a bolt hole 34. The key 48 of the top plate 20 is the shape of the material that forms the keyway 46 that is accessed from the bottom side of the top plate 20.

As shown in FIG. 1, the base plate assembly mounts to the shaft 14 of the picker hub 10, so that the key 16 of the shaft 14 engages the keyway 38 of the key coupler 24. Whereby, the threaded bolt hole 18 and the bolt hole 34 in the key 32 of the key coupler 24 are aligned. The fingers 12 are inserted into the finger holes 42 of the top plate 20 from the bottom side of the top plate 20. The top plate 20 is installed onto the base plate assembly so that key 32 of the key coupler 24 engages the keyway 46 of the top plate 20 from the bottom side of the top plate 20. Whereby, the bolt hole 34 of the key coupler 24 and the bolt hole 34 in the key 48 of the top plate 20 are aligned. The fingers 12 are now trapped between the top plate 20 and the base plate 22. A bolt 50 is inserted into the bolt holes 34 of the top plate 20 and key coupler 24 and then threaded into the threaded bolt hole 18 of the picker hub 10. The bolt 50 secures the finger plate system and the fingers 12 to the picker hub 10. The spacer 26 of the key coupler 24 provides clearance for the heads 52 of the fingers 12.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof

I claim:

1. A finger plate system for a picker hub that employs fingers to pick poultry feathers comprising:
a base plate adapted to attached to the picker hub; and
a top plate with finger holes that attaches to said base plate, said finger holes adapted to receive the fingers, said attachment of said top plate to said base plate adapted to trap and hold the fingers.

2. The finger plate system of claim 1, wherein said top plate and said base plate bolt together.

3. The finger plate system of claim 1, further including a spacer between said base plate and said top plate, said spacer adapted to provide clearance to the fingers.

4. The finger plate system of claim 1, wherein said base plate includes a keyway, said keyway of said base plate adapted to engage a key on a shaft of the picker hub.

5. The finger plate system of claim 4, wherein top plate includes a keyway to engage a key extending from said base plate.

6. The finger plate system of claim 1, wherein said base plate includes a key coupler and flat round plate with a bottom side and top side, said key coupler includes a spacer extending up from said top side of said flat round plate, said key coupler including a key extending from said top of said spacer, said bottom of said key coupler includes a key cavity adapted to a shaft of the picker hub, said key cavity includes a keyway adapted to receive a key on top of the shaft of the picker hub.

7. The finger plate system of claim 6, wherein top plate includes a keyway to engage a key extending from said spacer.

8. The finger plate system of claim 6, wherein said key coupler includes a bolt hole that is adapted to align with a threaded bolt hole of the shaft.

9. The finger plate system of claim 7, wherein said top plate includes a bolt hole aligns a bolt hole of said key coupler.

10. The finger plate system of claim 6, wherein said base plate includes a key coupler hole and wherein said key coupler is pressed into said key coupler hole.
